(19) United States
(12) Patent Application Publication
(10) Pub. No.: US 2019/0230546 A1
(43) Pub. Date: Jul. 25, 2019

(54) USER EQUIPMENT AND TRANSMISSION METHOD

(71) Applicant: NTT DOCOMO, INC., Tokyo (JP)

(72) Inventors: Hideaki Takahashi, Tokyo (JP); Tooru Uchino, Tokyo (JP); Wuri Andarmawanti Hapsari, Tokyo (JP); Anil Umesh, Tokyo (JP); Sadayuki Abeta, Tokyo (JP)

(73) Assignee: NTT DOCOMO, INC., Tokyo (JP)

(21) Appl. No.: 16/324,778

(22) PCT Filed: Jul. 31, 2017
(86) PCT No.: PCT/JP2017/027620

§ 371 Date: Feb. 11, 2019

(30) Foreign Application Priority Data
Aug. 26, 2016 (JP) 2016-166198

(51) Int. Cl. H04W 24/10; H04L 5/00; H04W 72/08; H04W 88/02; H04W 72/04

(52) U.S. Cl. CPC H04W 24/10; H04L 5/0051; H04W 72/0413; H04W 88/02; H04W 72/085

(57) ABSTRACT

A user equipment in a wireless communication system that includes a base station and the user equipment, the user equipment includes: a reception unit that receives allocations of radio resources to be used for transmitting uplink reference signals from the base station; a measurement unit that measures reception quality of downlink signals transmitted from the base station; and a transmission unit that starts transmitting uplink reference signals using the radio resources allocated from the base station when the reception quality measured by the measurement unit satisfies a predetermined condition and stops transmission of uplink reference signals when the reception quality measured by the measurement unit does not satisfy the predetermined condition.

### TECHNICAL FIELD

The present invention relates to a user equipment and a transmission method.

### BACKGROUND ART

In LTE (Long Term Evolution), a next-generation (called 5G) wireless communication system has been discussed in order to realize a larger system capacity, a higher data transmission rate, and a lower latency in a wireless segment. In 5G, various elemental techniques have been discussed to satisfy requirements that a latency in a wireless segment is to be equal to or smaller than 1 ms while realizing throughput of 10 Gbps or higher. Since it is highly likely that 5G employs a wireless technique different from LTE, a radio network that supports 5G is referred to as a new radio network (NewRAT: New Radio Access Network) in 3GPP so as to be distinguished from the radio network that supports LTE.

It is expected that 5G uses a wide range of frequencies from a low frequency range similar LTE to a higher frequency range higher than LTE. Since a propagation loss increases particularly in a high frequency range, it is discussed to apply beam forming with a narrow beam width in order to compensate for the increase in the propagation loss.

### CITATION LIST

### Non-Patent Document

### Non-Patent Document 1: NTT DOCOMO Corporation, NTT DOCOMO Technical Journal, “5G Radio Access Technology,” January 2016

### SUMMARY OF THE INVENTION

### Problem to be Solved by the Invention

In LTE, a base station performs a handover process on the basis of DL (Downlink) reception quality reported from a user equipment in the RRC connected state. On the other hand, since 5G performs beam forming using a high frequency range, it is considered necessary to perform a handover process at a higher speed and a higher frequency than LTE. Therefore, it is proposed in 5G to allow a plurality of base stations to receive UL (Uplink) reference signals to measure the radio quality of a user equipment that is to be understood by the base station in order to perform a handover process.

However, current LTE defines a periodic SRS (Sounding Reference Signal) in which UL reference signals are transmitted periodically and an aperiodic SRS in which reference signals are transmitted when instructed from a base station as a transmission method when a user equipment UE transmits UL reference signals.

When radio quality is measured, reference signals are generally received a plurality of number of times and an average value thereof is calculated. However, when periodic SRS is applied as it is, the user equipment has to transmit UL reference signals at all times and the power consumed by the user equipment increases. On the other hand, in the aperiodic SRS, the base station has to transmit one DCI (Downlink Control Information) to the user equipment in one SRS transmission. In this case, the base station has to transmit DCI a number of times to allow the user equipment UE to transmit SRS a plurality of number of times, and the signaling amount of DL increases too much. That is, it is not efficient to apply the UL reference signal transmission method defined in the current LTE to 5G from the perspective of acceleration of the handover process.

The disclosed technique has been in view of the above-described circumstance, and an object thereof is to provide a technique for enabling UL reference signals to be transmitted efficiently in a wireless communication system that includes a user equipment and a base station.

### Means for Solving Problem

A user equipment of the disclosed technique is a user equipment in a wireless communication system that includes a base station and the user equipment, the user equipment including: a reception unit that receives allocations of radio resources to be used for transmitting uplink reference signals from the base station; a measurement unit that measures reception quality of downlink signals transmitted from the base station; and a transmission unit that starts transmitting uplink reference signals using the radio resources allocated by the base station when the reception quality measured by the measurement unit satisfies a predetermined condition and stops transmission of uplink reference signals when the reception quality measured by the measurement unit does not satisfy the predetermined condition.

### Effect of the Invention

According to the disclosed technique, a technique for enabling UL reference signals to be transmitted efficiently in a wireless communication system that includes a user equipment and a base station is provided.

### BRIEF DESCRIPTION OF DRAWINGS

FIG. 1 is a diagram illustrating a configuration example of a wireless communication system according to an embodiment;

FIG. 2 is a sequence diagram illustrating a first example of a processing procedure that the wireless communication system according to the embodiment performs;

FIG. 3 is a flowchart illustrating an example of an operation of determining whether UL reference signals will be transmitted or the transmission will be stopped;

FIG. 4 is a diagram illustrating a specific example of a radio resource used for transmitting UL reference signals;

FIG. 5 is a flowchart illustrating an example of an operation when transmitting a measurement report;

FIG. 6 is a sequence diagram illustrating a second example of a processing procedure that the wireless communication system according to the embodiment performs;

FIG. 7 is a diagram illustrating an example of a functional configuration of a base station according to an embodiment;

FIG. 8 is a diagram illustrating an example of a functional configuration of a user equipment according to an embodiment; and

FIG. 9 is a diagram illustrating an example of a hardware configuration of a base station and a user equipment according to an embodiment.

### MODE(S) FOR CARRYING OUT THE INVENTION

Hereinafter, an embodiment of the invention will be described with reference to the drawings. The embodiment to be described below is an example only, and an embodiment to which the invention is applied is not limited to the following embodiment. For example, although a wireless communication system according to the present embodiment is a system of a scheme compatible with LTE, the invention is not limited to LTE but can be applied to other schemes. In the present specification and the claims, “LTE” is used in a broad sense to include 5G communication schemes corresponding to 3GPP release 10, 11, 12, 13, 14, or later as well as communication schemes corresponding to 3GPP release 8 or 9. In the following description, “resource” is used in the meaning of radio resource.

<System Configuration>

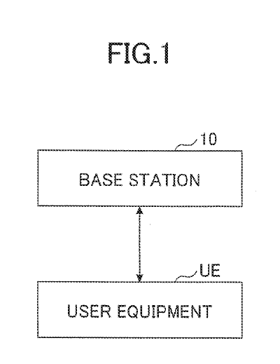

FIG. 1 is a diagram illustrating a configuration example of a wireless communication system according to an embodiment. As illustrated in FIG. 1, the wireless communication system according to the present embodiment includes a base station 10 and a user equipment UE. Although one base station 10 and one user equipment UE are illustrated in FIG. 1, this is an example only, and a plurality of base stations and a plurality of user equipments UEs may be provided.

The user equipment UE transmits UL reference signals using a resource allocated from the base station 10. Moreover, the user equipment UE switches whether UL reference signals will be transmitted or the transmission will be stopped according to a predetermined condition. The UL reference signals transmitted by the user equipment UE may be reference signals having the same sequence (CAZAC sequence) as the SRS (Sounding Reference Signal) defined in the LTE and may be reference signals (including reference signals newly defined in NewRAT) having a different sequence from the SRS.

The base station 10 has a function of allocating resources to be used for transmitting UL reference signals to each user equipment and measuring the UL reference signals transmitted from the user equipment UE. The base station 10 may manage one cell and may manage a plurality of cells.

The user equipment UE and the base station 10 can perform CA (Carrier Aggregation). Moreover, CA includes DC (Dual Connectivity).

<First Processing Procedure>

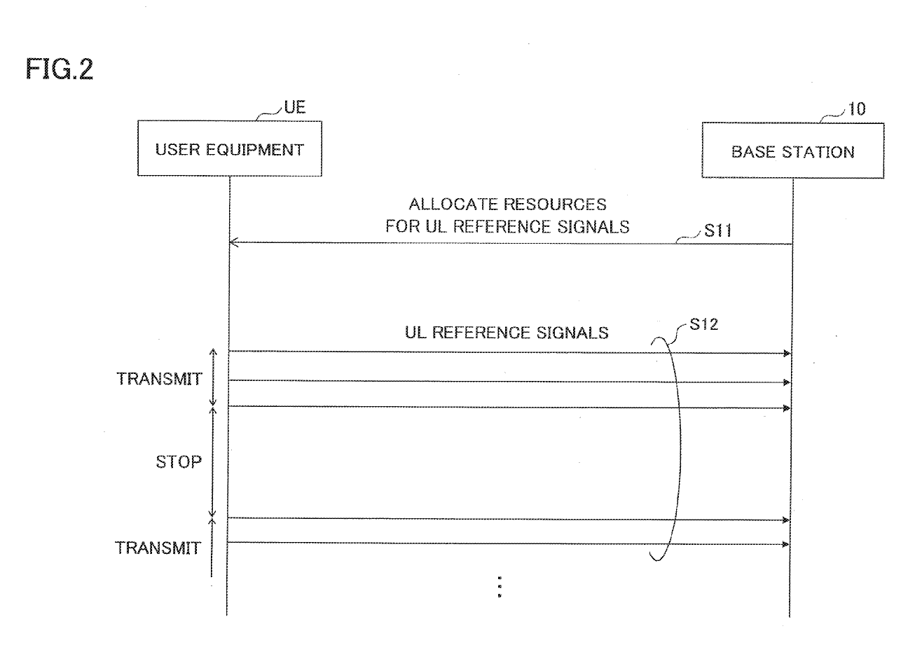

FIG. 2 is a sequence diagram illustrating a first example of a processing procedure that the wireless communication system according to the embodiment performs.

In step S11, the base station 10 allocates resources to be used for transmitting UL reference signals to the user equipment UE. For example, the base station 10 performs resource allocation by configuring “information indicating resources for UL reference signals” to the user equipment UE using RRC (Radio Resource Configuration) signaling. The “information indicating resources for UL reference signals” includes time resources (a subframe number, a reference parameter number, a transmission interval, and the like), frequency resources (a bandwidth, a frequency position, and the like), and the like capable of transmitting UL reference signals, for example.

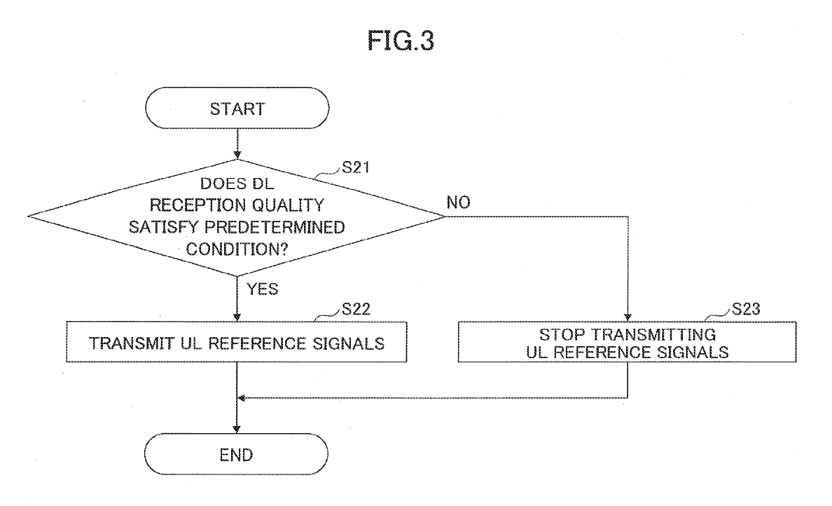

In step S12, the user equipment UE switches whether UL reference signals will be transmitted or the transmission will be stopped according to a predetermined condition. FIG. 3 illustrates an operation that the user equipment UE performs in step S12.

FIG. 3 is a flowchart illustrating an example of an operation of determining whether UL reference signals will be transmitted or the transmission will be stopped. First, the user equipment UE measures the reception quality of DL signals and determines whether the measured reception quality satisfies a predetermined condition (S21).

The DL signals measured by the user equipment UE may be synchronization signals (for example, PSS (Primary Synchronization Signal) and SSS (Secondary Synchronization Signal)), cell-specific DL reference signals (for example, CRS (Cell specific Reference Signal)), and/or UE-specific DL reference signals (for example, CST-RS (Channel State Information-Reference Signal) and DM-RS (Demodulation-Reference Signal)). The DL signals measured by the user equipment UE are not limited to these signals but may be reference signals newly defined exclusively for NewRAT. For example, in the NewRAT, it is expected that reference signals for beam forming control are newly defined as UE-specific DL reference signals.

Moreover, the reception quality of the DL signals measured by the user equipment UE may be RSRP (Reference Signal Received Power), RSRQ (Reference Signal Received Quality), RS-SINR (Reference Signal-Signal to Interference plus Noise power Ratio), or CQI (Channel Quality Indicator), for example. Moreover, the reception quality measured by the user equipment UE is not limited to these but may be a measurement indicator that is newly defined exclusively for the NewRAT.

Subsequently, when the measured reception quality of the DL signals satisfies a predetermined condition, the user equipment UE starts transmitting UL reference signals using resources allocated from the base station 10 (S22). When the measured reception quality of the DL signals does not satisfy the predetermined condition, the user equipment UE stops transmitting the UL reference signals (S23).

### SPECIFIC EXAMPLE

Next, a specific example of an operation of determining whether the user equipment UE transmits UL reference signals or stops the transmission will be described according to the flowchart of FIG. 3.

### First Specific Example

When the reception quality of DL signals transmitted from a serving cell is larger than (or equal to or larger than) a threshold (S21: Yes), transmission of UL reference signals starts (S22). On the other hand, when the reception quality of DL signals transmitted from the serving cell is smaller than (or equal to or smaller than) the threshold (S21: No), transmission of UL reference signals is stopped (S23).

More specifically, the user equipment UE may start transmitting UL reference signals when the reception quality of DL signals satisfies Equation 1-1 and may stop transmitting UL reference signals when the reception quality of DL signals satisfies Equation 1-2.

Ms−Hys>Threshold (Equation 1-1)

Ms+Hys<Threshold (Equation 1-2)

Here, “Ms” indicates the reception quality of DL signals. “Hys” indicates hysteresis. In the present embodiment, by providing hysteresis, frequent switching between transmission of UL reference signals and stopping of the transmission is suppressed when the reception quality of DL signals is close to the threshold (the same is true for the other specific examples). Although the hysteresis may be a positive value and a negative value, the hysteresis in the present embodiment is preferably a positive value.

According to the first specific example, the user equipment UE can transmit UL reference signals when the user equipment UE is positioned in a central direction and can stop transmitting UL reference signals when the user equipment UE is positioned in a cell-end direction.

### Second Specific Example

When the reception quality of DL signals transmitted from the serving cell is smaller than (or equal to or smaller than) the threshold (S21: Yes), transmission of UL reference signals starts (S22). On the other hand, when the reception quality of DL signals transmitted from a serving cell is larger than (or equal to or larger than) a threshold (S21: No), transmission of UL reference signals is stopped (S23).

More specifically, the user equipment UE may start transmitting UL reference signals when the reception quality of DL signals satisfies Equation 2-1 and may stop transmitting UL reference signals when the reception quality of DL signals satisfies Equation 2-2.

Ms+Hys<Threshold (Equation 2-1)

Ms−Hys>Threshold (Equation 2-2)

Here, “Ms” indicates the reception quality of DL signals. “Hys” indicates hysteresis.

According to the first specific example, the user equipment UE can transmit UL reference signals when the user equipment UE is positioned in a cell-end direction of the serving cell and can stop transmitting UL reference signals when the user equipment UE is positioned in a central direction of the serving cell.

### Third Specific Example

When the reception quality of DL signals of a neighboring cell is larger than (or equal to or larger than) the reception quality of DL signals of the serving cell (S21: Yes), transmission of UL reference signals starts (S22). On the other hand, when the reception quality of DL signals of the neighboring cell is smaller than (or equal to smaller than) the reception quality of DL signals (S21: No), transmission of UL reference signals is stopped (S23).

More specifically, the user equipment UE may start transmitting UL reference signals when Equation 3-1 is satisfied and may stop transmitting UL reference signals when Equation 3-2 is satisfied.

Mn+Ofn−Ocn−Hys>Mp+Ofp+Ocp+Off (Equation 3-1)

Mn+Ofn+Ocn+Hys<Mp+Ofp+Ocp+Off (Equation 3-2)

Here, “Mn” indicates the reception quality of DL signals of the neighboring cell. “Ofn” indicates a frequency-specific offset value in relation to the frequency of the neighboring cell. “Ocn” indicates a cell-specific offset value in relation to the neighboring cell. “Mp” indicates the reception quality of DL signals of the serving cell. “Ofp” indicates a frequency-specific offset value in relation to the frequency of the serving cell. “Ocp” indicates a cell-specific offset value in relation to the serving cell. “Hys” indicates hysteresis. “Off” indicates an arbitrary offset value. In the third specific example, the serving cell may be PCell or PSCell (when DC is performed).

According to the third specific example, the user equipment UE can transmit UL reference signals when the reception quality or the neighboring cell is better than the serving cell and can stop transmitting UL reference signals when the reception quality of the serving cell is better than the neighboring cell.

### Fourth Specific Example

When the reception quality of DL signals of the neighboring cell is larger than (or equal to or larger than) a threshold (S21: Yes), transmission of UL reference signals starts (S22). On the other hand, when the reception quality of DL signals of the neighboring cell is smaller (equal to or smaller than) the threshold (S21: No), transmission of UL reference signals is stopped (S23).

More specifically, the user equipment UE may start transmitting UL reference signals when the reception quality of DL signals satisfies Equation 4-1 and may stop transmitting UL reference signals when the reception quality of DL signals satisfies Equation 4-2.

Mn+Ofn+Ocn−Hys>Threshold (Equation 4-1)

Mn+Ofn+Ocn+Hys<Threshold (Equation 4-2)

Here, “Mn” indicates the reception quality of DL signals of the neighboring cell. “Ofn” indicates a frequency-specific offset value in relation to the frequency of the neighboring cell. “Ocn” indicates a cell-specific offset value in relation to the neighboring cell. “Hys” indicates hysteresis.

According to the fourth specific example, the user equipment UE can transmit UL reference signals when the user equipment UE is positioned near the neighboring cell and can stop transmitting UL reference signals when the user equipment UE is positioned distant from the neighboring cell.

### Fifth Specific Example

When the reception quality of DL signals of the serving cell is smaller than (or equal to or smaller than) a first threshold and the reception quality of DL signals of the neighboring cell is larger than (or equal to or larger than) a second threshold (S21: Yes), transmission of UL reference signals starts (S22).

On the other hand, when the reception quality of DL signals of the serving cell is larger than (or equal to or larger than) the first threshold or the reception quality of DL signals of the neighboring cell is smaller than (equal to or smaller than) the threshold (S21: No), transmission of UL reference signals is stopped (S23).

More specifically, the user equipment UE may start transmitting UL reference signals when the reception quality of DL signals satisfies both Equations 501 and 502 and may stop transmitting UL reference signals when the reception quality of DL signals satisfies Equation 5-3 or 5-4.

Mp+Hys<First threshold (Equation 5-1)

Mn+Ofn+Ocn−Hys>Second threshold (Equation 5-2)

Mp−Hys>First threshold (Equation 5-3)

Mn+Ofn+Ocn+Hys<Second threshold (Equation 5-4)

Here, “Mp” indicates the reception quality of DL signals of the serving cell. “Mn” indicates the reception quality of DL signals of the neighboring cell. “Ofn” indicates a frequency-specific offset value in relation to the frequency of the neighboring cell. “Ocn” indicates a cell-specific offset value in relation to the neighboring cell. “Hys” indicates hysteresis. In the fifth specific example, the serving cell may be PCell or PSCell (when DC is performed).

According to the fifth specific example, the user equipment UE can transmit UL reference signals when the user equipment UE is positioned near the neighboring cell and can stop UL reference signals when the user equipment UE is positioned away from the neighboring cell.

### Sixth Specific Example

When the reception quality of DL signals of the neighboring cell is larger than (equal to or larger than) the reception quality of DL signals of a secondary cell (SCell in CA/DC) (S21: Yes), transmission of UL reference signals starts (S22). On the other hand, when the reception quality of DL signals of the neighboring cell is smaller than (equal to or smaller than) the reception quality of DL signals of the secondary cell (S21: No), transmission of UL reference signals is stopped (S23).

More specifically, the user equipment UE may start transmitting UL reference signals when Equation 6-1 is satisfied and may stop transmitting UL reference signals when Equation 6-2 is satisfied.

Mn+Ocn−Hys>Ms+Ocs+Off (Equation 6-1)

Mn+Ocn+Hys<Ms+Ocs+Off (Equation 6-2)

Here, “Mn” indicates the reception quality of DL signals of the neighboring cell. “Ocn” indicates a cell-specific offset value in relation to the neighboring cell. “Ms” indicates the reception quality of DL signals of the secondary cell. “Ocs” indicates a cell-specific offset value in relation to the secondary cell. “Hys” indicates hysteresis. “Off” indicates an arbitrary offset value.

According to the sixth specific example, the user equipment UE that is executing CA/DC can transmit UL reference signals when the reception quality of the neighboring cell is better than the secondary cell and can stop transmitting UL reference signals when the reception quality of the secondary cell is better than the neighboring cell.

### Seventh Specific Example

When the reception quality of UE-specific DL reference signals (CSI-RS, DM-RS, reference signals for beam forming control, and the like) is larger than (or equal to or larger than) a threshold (S21: Yes), transmission of UL reference signals starts (S22). On the other hand, when the reception quality of UE-specific DL reference signals is smaller than (or equal to or smaller than) the threshold (S21: No), transmission of UL reference signals is stopped (S23).

More specifically, the user equipment UE may start transmitting UL reference signals when the reception quality of UE-specific DL reference signals satisfies Equation 7-1 and may stop transmitting UL reference signals when the reception quality of UE-specific DL reference signals satisfies Equation 7-2.

Mcr+Ocr−Hys>Threshold (Equation 7-1)

Mcr+Ocr+Hys<Threshold (Equation 7-2)

Here, “Mcr” indicates the reception quality of UE-specific DL reference signals “Ocr” indicates an offset value specific to UE-specific DL reference signals. “Hys” indicates hysteresis.

According to the seventh specific example, the user equipment UE can transmit UL reference signals when the user equipment UE is positioned in a central direction of the cell using the UE-specific DL reference signals and can stop transmitting UL reference signals when the user equipment UE is positioned in a cell-end direction.

### Eighth Specific Example

When the reception quality of UE-specific DL reference signals (CSI-RS, DM-RS, reference signals for beam forming control, and the like) is smaller than (or equal to or smaller than) a threshold (S21: Yes), transmission of UL reference signals starts (S22). On the other hand, when the reception quality of UE-specific DL reference signals is larger than (or equal to or larger than) the threshold (S21: No), transmission of UL reference signals is stopped (S23).

More specifically, the user equipment UE may start transmitting UL reference signals when the reception quality of UE-specific DL reference signals satisfies Equation 8-1 and may stop transmitting UL reference signals when the reception quality of UE-specific DL reference signals satisfies Equation 8-2.

Mcr+Ocr+Hys<Threshold (Equation 8-1)

Mcr+Ocr−Hys>Threshold (Equation 8-2)

Here, “Mcr” indicates the reception quality of UE-specific DL reference signals. “Ocr” indicates an offset value specific to UE-specific DL reference signals. “Hys” indicates hysteresis.

According to the eighth specific example, the user equipment UE can transmit UL reference signals when the user equipment UE is positioned in a cell-end direction using the UE-specific DL reference signals and can stop transmitting UL reference signals when the user equipment UE is positioned in a central direction of the cell.

### Ninth Specific Example

When the reception quality of UE-specific DL reference signals is larger than (or equal to or larger than) the reception quality of a UE-specific DL reference signal used as a reference (S21: Yes), transmission of UL reference signals starts (S22). On the other hand, when the reception quality of UE-specific DL reference signals is smaller than (or equal to or smaller than) the reception quality of a UE-specific DL reference signal used as a reference (S21: No), transmission of UL reference signals is stopped (S23).

More specifically, the user equipment UE may start transmitting UL reference signals when Equation 9-1 is satisfied and may stop transmitting UL reference signals when Equation 9-2 is satisfied.

Mcr+Ocr−Hys>Mref+Oref+Off (Equation 9-1)

Mcr+Ocr+Hys<Mref+Oref+Off (Equation 9-2)

Here, “Mcr” indicates the reception quality of UE-specific DL reference signals. “Ocr” indicates an offset value specific to UE-specific DL reference signals. “Mref” indicates the reception quality of a UE-specific DL reference signal used as a reference. “Oref” indicates an offset value unique to a UE-specific DL reference signal used as a reference. “Hys” indicates hysteresis. “Off” indicates an arbitrary offset value. Here, the UE-specific DL reference signal used as a reference means a UE-specific DL reference signal transmitted by a specific resource among a plurality of UE-specific DL reference signals transmitted from the base station 10, and the location of the specific resource is notified (configured) in advance from the base station 10 to the user equipment UE.

According to the ninth specific example, the user equipment UE can transmit UL reference signals when the reception quality of UE-specific DL reference signals is larger than the reception quality of UE-specific DL reference signal as a reference using the UE-specific DL reference signals and can stop transmitting UL reference signals when the reception quality of the UE-specific DL reference signal used as a reference is larger than the reception quality of the UE-specific DL reference signals.

[Supplementary Explanation of Specific Examples]

The user equipment UE may start transmitting UL reference signals when the reception quality of DL signals satisfies a predetermined condition continuously for a “predetermined period” (that is, Equation 1-1, 2-1, 3-1, 4-1, 5-1, 6-1, 7-1, 8-1, or 9-1 is satisfied continuously for the “predetermined period”). Similarly, the user equipment UE may stop transmitting UL reference signals when the reception quality of DL signals does not satisfy a predetermined condition continuously for a “predetermined period” (that is, Equation 1-1, 2-1, 3-1, 4-1, 5-1, 6-1, 7-1, 8-1, or 9-1 is not satisfied continuously for the “predetermined period”). The predetermined period may be referred to as a time to trigger. The predetermined period may be notified (configured) from the base station 10 to the user equipment UE using the processing procedure of step S11 in FIG. 2. In this way, it is possible to prevent frequent switching between transmission of UL reference signals and stopping of the transmission.

Various parameters (Hys, Ofn, Ocn, Ofp, Ocp, Off, Ocs, Mcr, Ocr, Mref, Oref, and thresholds) used in the specific examples may be notified (configured) from the base station 10 to the user equipment UE using the processing procedure of step S11 in FIG. 2. As the parameters used in the specific examples, the same values common for the respective specific examples may be notified (configured) and different values for the respective specific examples may be notified (configured).

The user equipment UE may autonomously select and execute an arbitrary specific example among the plurality of specific examples. Moreover, the user equipment UE may execute a specific example instructed from the base station 10 among a plurality of specific examples illustrated in below. The instruction may be performed using the processing procedure of step S11 in FIG. 2.

(Resource for Transmitting UL Reference Signals)

As described in FIG. 3, the base station 10 allocates resources to be used for transmitting UL reference signals to the user equipment UE. Moreover, the user equipment UE transmits UL reference signals using the resources allocated from the base station 10.

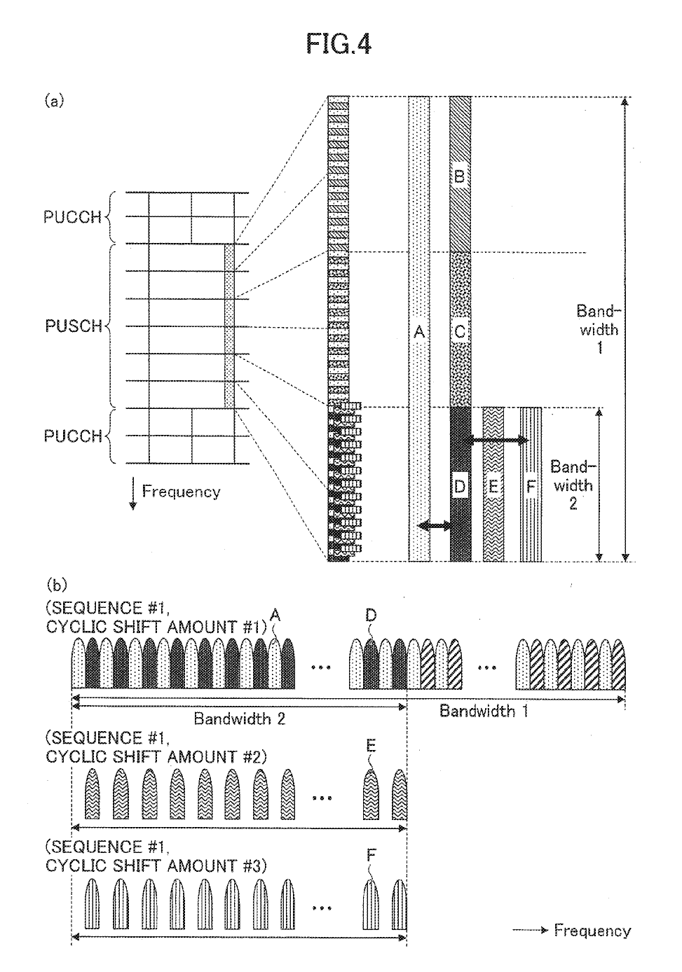

Here, a specific example of resources in a frequency direction, allocated from the base station 10 to the user equipment UE will be described with reference to FIG. 4. Although FIG. 4(a) illustrates a channel configuration in which PUCCH (Physical Uplink Control Channel) is allocated to upper and lower parts of a band, this is an example only and the present invention is not limited to this.

The base station 10 may allocate resources for UL reference signals to a predetermined band (for example, Bandwidth 1 in FIG. 4) which can be used for UL reference signals in a cell and may allocate resources for UL reference signals to a partial band (for example, Bandwidth 2 in FIG. 4). Moreover, as illustrated in FIG. 4(b), the base station 10 may allocate resources every alternate subcarrier (that is, in a comb shape) so that two resources (for example, resources “A” and “D”) are frequency-multiplexed. Moreover, the base station 10 may designate different cyclic shift (phase rotation) amounts to respective user equipments UEs so that a plurality of UL reference signals are code-multiplexed to the same resource (for example, resources “D,” “E,” and “F”).

When resources are allocated as illustrated in FIG. 4, the base station 10 notifies (configures) a bandwidth and a frequency position, information for specifying a comb shape (information indicating an odd-numbered subcarrier or an even-numbered sequencer), and a cyclic shift amount to the user equipment UE as resources for UL reference signals.

According to the first processing procedure described above, the user equipment UE transmits UL reference signals when a predetermined condition is satisfied only rather than transmitting UL reference signals at all times. In this way, the user equipment UE can efficiently transmit UL reference signals. Moreover, it is possible to reduce power consumed by the user equipment UE and to reduce a signaling amount.

<First Modification of First Processing Procedure>

Next, a first modification of the first processing procedure will be described. In the first modification of the first processing procedure, the base station 10 allocates a plurality of resources for UL reference signals to the user equipment UE and correlates different resources with respective ranges of reception quality of DL signals. Moreover, the user equipment UE selects a resource correlated with the measured reception quality of the DL signals and transmits UL reference signals.

Specifically, for example, the user equipment UE may select Resource 1 and transmit UL reference signals when the reception quality of DL signals is equal to or larger than −90 dBm and smaller than −80 dBm and may select Resource 2 and transmit UL reference signals when the reception quality is equal to or larger than −100 dBm and smaller than −90 dBm.

A specific example will be described further with reference to FIG. 4. For example, the user equipment UE may select Resource “A” and transmit UL reference signals when the reception quality of DL signals is equal to or larger than −90 dBm and smaller than −80 dBm, select Resource “B” and transmit UL reference signals when the reception quality of DL signals is equal to or larger than −110 dBm and smaller than −90 dBm, select Resource “C” and transmit UL reference signals when the reception quality of DL signals is equal to or larger than −110 dBm and smaller than −100 dBm, select Resource “D” and transmit UL reference signals when the reception quality of DL signals is equal to or larger than −120 dBm and smaller than −110 dBm, select Resource “E” and transmit UL reference signals when the reception quality of DL signals is equal to or larger than −130 dBm and smaller than −120 dBm, and select Resource “F” and transmit UL reference signals when the reception quality of DL signals is equal to or larger than −140 dBm and smaller than −130 dBm.

In the third, fifth, sixth, and ninth specific examples among the above-described specific examples, the user equipment UE measures the reception quality of a plurality of DL signals. Therefore, when the “first modification of the first processing procedure” is combined with the above-described specific examples, the base station 10 may indicate (configure) the reception quality of the DL signal to be used for selecting resources among the reception quality of the plurality of DL signals to the user equipment UE. This indication may be performed using the processing procedure of step S11 in FIG. 2.

For example, in the third and fifth specific examples, the user equipment UE may select resources using the reception quality of the DL signal of the cell indicated by the base station 10 among the neighboring cell and the serving cell. Similarly, in the sixth specific example, the user equipment UE may select resources using the reception quality of the DL signal of the cell indicated by the base station 10 among the neighboring cell and the secondary cell. Similarly, in the ninth specific example, the user equipment UE may select resources using the reception quality of the DL reference signal indicated from the base station 10 among the UE-specific DL reference signal and the UE-specific DL reference signal used as a reference.

According to the first modification of the first processing procedure described above, the base station 10 can understand the range of reception quality of the DL signals measured by the user equipment UE by receiving the UL reference signals.

<Second Modification of First Processing Procedure>

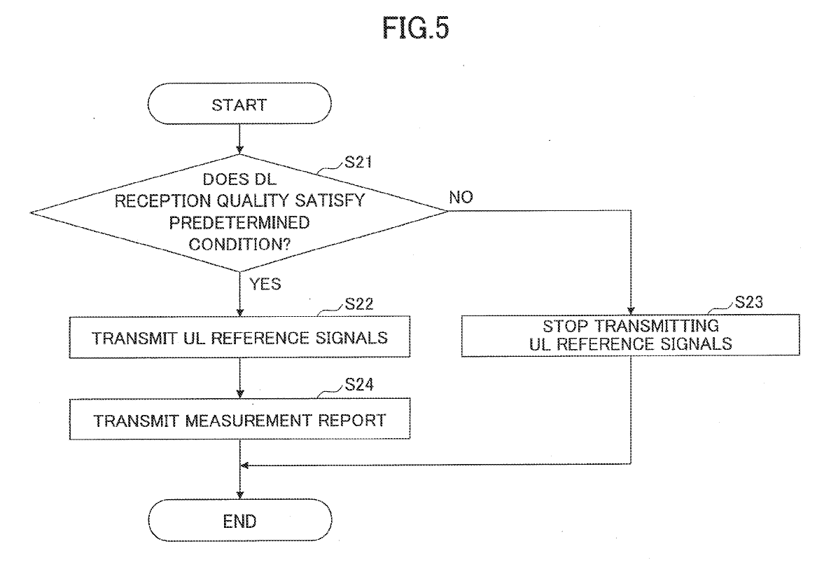

The user equipment UE may report the measured reception quality of the DL signal to the base station 10 when starting transmission of UL reference signals using the resource allocated from the base station 10. FIG. 5 is a flowchart illustrating an example of an operation when transmitting a measurement report. The same processing procedures in FIG. 5 as those of FIG. 3 will be denoted by the same reference numerals and the description thereof will be omitted.

The user equipment UE transmits (reports) a measurement report including the reception quality of DL measured in step S21 to the base station 10 when starting transmission of UL reference signals (S24). The user equipment UE may transmit (report) the measurement report to the base station 10 periodically when UL reference signals are being transmitted (that is, until transmission of UL reference signals is stopped).

In this way, the base station 10 can understand the reception quality of the DL signals measured by the user equipment UE in detail.

<Second Processing Procedure>

As described above, in the aperiodic SRS of the conventional LTE, the base station 10 needs to transmit one DCI for one SRS transmission to the user equipment UE. Therefore, in the second processing procedure, the base station 10 may instruct the user equipment UE to transmit UL reference signals for a predetermined period.

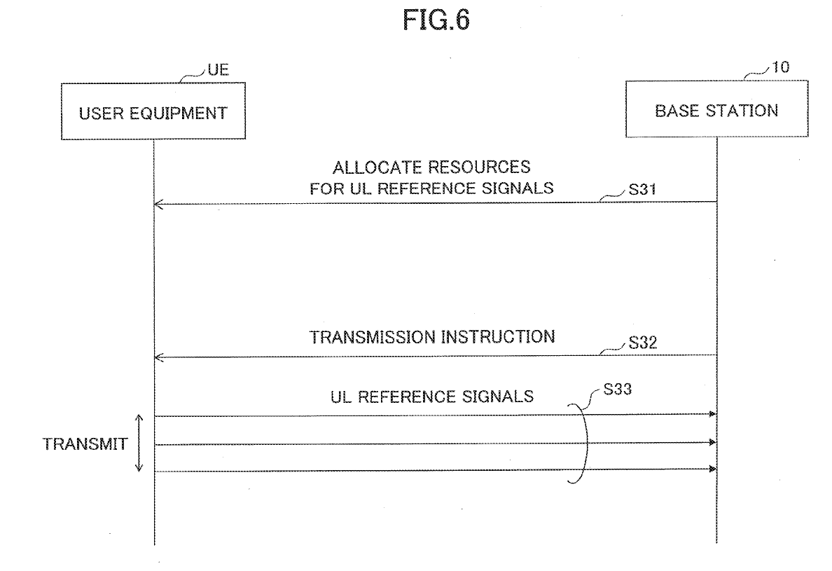

FIG. 6 is a sequence diagram illustrating an example of the second processing procedure that the wireless communication system according to the embodiment performs.

In step S31, the base station 10 allocates resources to be used for transmitting UL reference signals to the user equipment UE. A specific resource allocation method may be the same as the processing procedure of step S11 of the first processing procedure.

In step S32, the base station 10 transmits item identification information (hereinafter referred to as a “transmission instruction”) for instructing to start transmitting UL reference signals to the user equipment UE. The transmission instruction may be transmitted using PDCCH (Physical Downlink Control Channel). That is, the transmission instruction may be a portion of DCI.

The transmission instruction may include a period in which UL reference signals are to be transmitted. For example, the period in which UL reference signals are to be transmitted may be defined in advance so as to mean “00=1 seconds,” “01=2 seconds,” “10=5 seconds,” and “11=10 seconds,” using two bits. Moreover, the base station 10 may notify (configure) the period in which reference signals are to be transmitted in advance to the user equipment UE using a RRC signaling or notification information (broadcast information), and the user equipment UE may transmit UL reference signals for the notified (configured) period in advance upon receiving the transmission instruction in step S32.

According to the second processing procedure described above, the user equipment UE transmits UL reference signals for the period indicated from the base station 10 only rather than transmitting UL reference signals at all times. In this way, the user equipment UE can efficiently transmit UL reference signals. Moreover, it is possible to reduce power consumed by the user equipment UE and to reduce a signaling amount.

<Functional Configuration>

(Base Station)

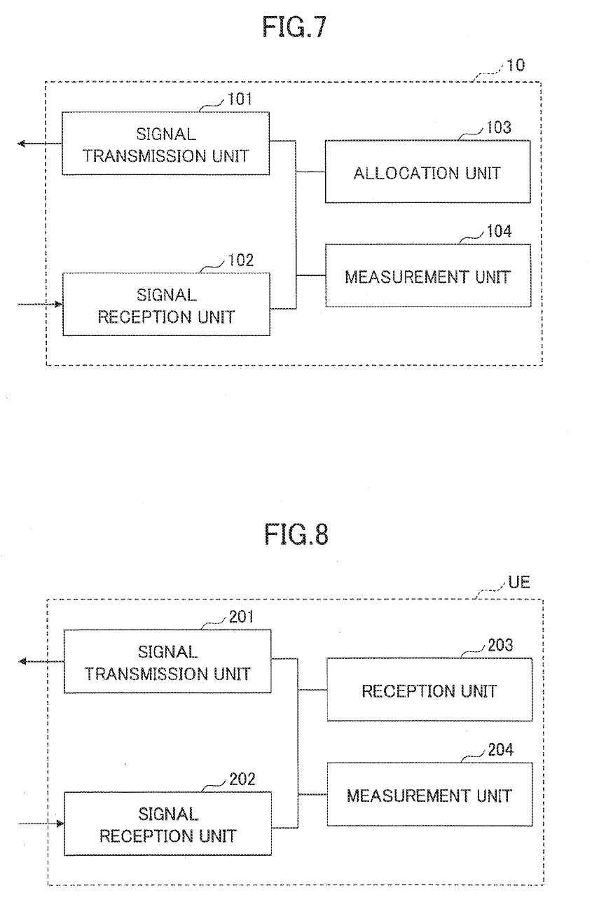

FIG. 7 is a diagram illustrating an example of a functional configuration of the base station according to the embodiment. As illustrated in FIG. 7, the base station 10 includes a signal transmission unit 101, a signal reception unit 102, an allocation unit 103, and a measurement unit 104. FIG. 7 illustrates functional units of the base station 10 particularly related to the embodiment only and also includes at least functions (not illustrated) for performing operations compatible with LTE (including 5G). Moreover, the functional configurations illustrated in FIG. 7 are examples only. The functional classifications and the names of the functional units are not particularly limited as long as the operations according to the present embodiment can be executed.

The signal transmission unit 101 includes a function of generating various signals of the physical layer from higher-layer signals to be transmitted from the base station and transmitting the signals wirelessly. The signal reception unit 102 includes a function of wirelessly receiving various radio signals from the user equipment UE and acquiring higher-layer signals from the received physical layer signals.

The allocation unit 103 allocates resources to be used for transmitting UL reference signals to the user equipment UE by notifying (configuring) time resources (a subframe number, a reference parameter number, a transmission interval, and the like) capable of transmitting UL reference signals, a frequency resource (a bandwidth, a frequency position, and the like) to the user equipment UE using RRC signaling.

The measurement unit 104 measures the UL reference signals transmitted from the user equipment UE. The measurement result obtained by the measurement unit 104 is used for determining whether the user equipment UE will be instructed to perform a handover or not.

(User Equipment)

FIG. 8 is a diagram illustrating an example of a functional configuration of the user equipment according to the embodiment. As illustrated in FIG. 8, the user equipment UE includes a signal transmission unit 201, a signal reception unit 202, a reception unit 203, and a measurement unit 204. FIG. 8 illustrates functional units of the user equipment UE particularly related to the embodiment only and also includes at least functions (not illustrated) for performing operations compatible with LTE (including 5G). Moreover, the functional configurations illustrated in FIG. 8 are examples only. The functional classifications and the names of the functional units are not particularly limited as long as the operations according to the present embodiment can be executed.

The signal transmission unit 201 includes a function of generating various signals of the physical layer from higher-layer signals to be transmitted from the user equipment UE and transmitting the signals wirelessly. The signal reception unit 202 includes a function of wirelessly receiving various signals from the base station 10 and acquiring higher-layer signals from the received physical-layer signals.

The signal transmission unit 201 starts transmitting UL reference signals using the radio resources allocated from the base station 10 when the reception quality of DL signals measured by the measurement unit 204 satisfies a predetermined condition and stops transmitting the UL reference signals when the reception quality of the DL signals measured by the measurement unit 204 does not satisfy the predetermined condition. The signal transmission unit 201 may include determination unit that determines whether UL reference signals are to be transmitted or the transmission is to be stopped.

The radio resources allocated from the base station 10 may be allocated such that different radio resources are correlated with respective ranges of the reception quality of DL signals, and the signal transmission unit 201 may select radio resources correlated with the reception quality of the DL signals measured by the measurement unit 204 and transmit UL reference signals.

The signal transmission unit 201 may report the reception quality of DL signals measured by the measurement unit 204 to the base station 10 when starting transmission of UL reference signals using the radio resources allocated from the base station 10.

The signal transmission unit 210 may transmit uplink reference signals using the radio resources allocated from the base station 10 for the “period in which UL reference signals are to be transmitted” instructed from the base station 10 in advance and stop transmitting uplink reference signals in period other than the “period in which uplink reference signals are to be transmitted”.

The reception unit 203 receives allocations of radio resources to be used for transmitting UL reference signals from the base station 10. Moreover, the reception unit 203 may receive allocations of radio resources to be used for transmitting UL reference signals and a period in which UL reference signals are to be transmitted from the base station 10.

The measurement unit 204 measures the reception quality of DL signals transmitted from the base station 10. The measurement unit 204 may measure RSRP, RSRQ, RS-SINR, and/or CQI as the reception quality of DL signals.

<Hardware Configuration>

The block diagrams (FIGS. 7 and 8) used in the description of the embodiment illustrate functional blocks. These functional blocks (configuration units) are realized by an arbitrary combination of hardware and/or software. Moreover, means for realizing the respective functional blocks is not particularly limited. That is, the respective functional blocks may be realized by one apparatus which is physically and/or logically coupled and may be realized by a plurality of apparatuses which are physically and/or logically separated and which are directly and/or indirectly (for example, by cables and/or wirelessly) connected.

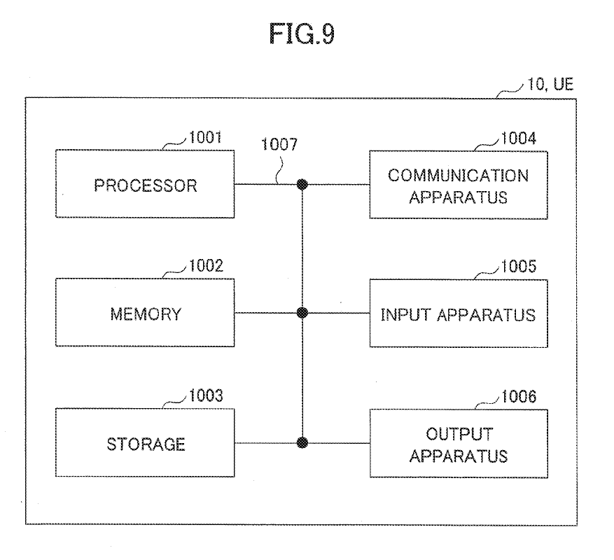

For example, the base station 10, the user equipment UE, and the like according to the embodiment may function as a computer that performs processing of the transmission method of the present invention. FIG. 9 is a diagram illustrating an example of a hardware configuration of the base station and the user equipment according to the embodiment. The base station 10 and the user equipment UE may be physically configured as a computer apparatus which includes a processor 1001, a memory 1002, a storage 1003, a communication apparatus 1004, an input apparatus 1005, an output apparatus 1006, a bus 1007, and the like.

In the following description, the wording “apparatus” may be replaced with circuit, device, unit, or the like. The hardware configuration of the base station 10 and the user equipment UE may include one or a plurality of apparatuses illustrated in the drawings and may not include some apparatuses.

The respective functions of the base station 10 and the user equipment UE are realized when predetermined software (program) is read onto hardware such as the processor 1001, the memory 1002, and the like, the processor 1001 performs an operation, and the communication by the communication apparatus 1004 and the data read and/or write in the memory 1002 and the storage 1003 are controlled.

The processor 1001 operates an operating system to control the entire computer, for example. The processor 1001 may be configured as a central processing unit (CPU) that includes an interface to a peripheral apparatus, a control apparatus, an operation apparatus, a register, and the like. For example, the signal transmission unit 101, the signal reception unit 102, the allocation unit 103, and the measurement unit 104 of the base station 10 and the signal transmission unit 201, the signal reception unit 202, the reception unit 203, and the measurement unit 204 of the user equipment UE may be realized by the processor 1001.

The processor 1001 reads a program (program codes), a software module, or data from the storage 1003 and/or the communication apparatus 1004 into the memory 1002 and executes various processes according to the program and the like. A program for causing a computer to execute at least a portion of the operations described in the embodiment is used as the program. For example, the signal transmission unit 101, the signal reception unit 102, and the allocation unit 103 of the user equipment UE and the signal transmission unit 201, the signal reception unit 202, the reception unit 203 of the base station 10 may be realized by a control program which is stored in the memory 1002 and operated by the processor 1001. Moreover, the other functional blocks may be realized by the processor. Although it has been described that the above-described processes are executed by one processor 1001, the processes may be executed by two or more processors 1001 simultaneously or sequentially. One or more chips may be mounted in the processor 1001. The program may be transmitted from a network via a telecommunication circuit.

The memory 1002 is a computer-readable recording medium and may be configured by at least one of a ROM (Read Only Memory), an EPROM (Erasable Programmable ROM), an EEPROM (Electrically Erasable Programmable ROM), a RAM (Random Access Memory), and the like, for example. The memory 1002 may be referred to as a register, a cache, a main memory (main storage device), and the like. The memory 1002 can store a program (program codes), a software module, and the like that can be executed to perform a signal transmission method according to an embodiment of the present invention.

The storage 1003 is a computer-readable recording medium and may be configured by at least one of an optical disc such as a CD-ROM (Compact Disc ROM), a hard disk drive, a flexible disk, an optomagnetic disc (for example, a compact disc, a digital versatile disc, or a Blu-ray (registered trademark) disc), a smartcard, a flash memory (for example, a card, stick, or a key drive), a floppy (registered trademark) disk, a magnetic strip, and the like, for example. The storage 1003 may be referred to as an auxiliary storage apparatus. The above-described storage medium may be an appropriate medium other than a database and a server that include the memory 1002 and/or the storage 1003.

The communication apparatus 1004 is hardware (transmission and reception device) for performing communication between computers via cables and/or a wireless network and is also referred to as a network device, a network controller, a network card, a communication module, and the like, for example. For example, the signal transmission unit 101 and the signal reception unit 102 of the base station 10 and the signal transmission unit 201 and the signal reception unit 202 of the user equipment UE may be realized by the communication apparatus 1004.

The input apparatus 1005 is an input device (for example, a keyboard, a mouse, a microphone, a switch, a button, a sensor, and the like) that receives the input from the outside. The output apparatus 1006 is an output device (for example, a display, speaker, an LED lamp, and the like) that outputs information to the outside. The input apparatus 1005 and the output apparatus 1006 may have an integrated configuration (for example, a touch panel).

The respective apparatuses such as the processor 1001 and the memory 1002 are connected by the bus 1007 for communicating information. The bus 1007 may be configured by a single bus and may be configured by different buses for respective apparatuses.

The base station 10 and the user equipment UE may be configured to include hardware such as a microprocessor, a digital signal processor (DSP), an ASIC (Application Specific Integrated Circuit), a PLD (Programmable Logic Device), an FPGA (Field Programmable Gate Array), and the like, and part or all of the respective functional blocks may be realized by the hardware. For example, the processor 1001 may be implemented by at least one of these items of hardware.

<Summary>

According to the embodiment, there is provided a user equipment in a wireless communication system that includes a base station and user equipments, the user equipment including: a reception unit that receives allocations of radio resources to be used for transmitting uplink reference signals from the base station; a measurement unit that measures the reception quality of downlink signals transmitted from the base station; and a transmission unit that starts transmitting uplink reference signals using a radio resource allocated from the base station when the reception quality measured by the measurement unit satisfies a predetermined condition and stops transmission of uplink reference signals when the reception quality measured by the measurement unit does not satisfy the predetermined condition. According to this user equipment UE, a technique for enabling UL reference signals to be transmitted efficiently in a wireless communication system that includes the user equipment UE and the base station 10 is provided.

The radio resource allocated from the base station may be allocated such that different radio resources are correlated with respective ranges of the reception quality of downlink signals, and the transmission unit may select a radio resource correlated with the reception quality measured by the measurement unit and transmits uplink reference signals. Due to this, the base station 10 can understand the range of reception quality of DL signals measured by the user equipment UE by receiving UL reference signals.

The transmission unit may report the reception quality measured by the measurement unit to the base station when starting transmission of uplink reference signals using the radio resource allocated from the base station. Due to this, the base station 10 can understand the reception quality of DL signals measured by the user equipment UE in detail.

According to the embodiment, there is provided a user equipment in a wireless communication system that includes a base station and user equipments, the user equipment including: a reception unit that receives allocations of radio resources to be used for transmitting uplink reference signals and a period in which uplink reference signals are to be transmitted from the base station; and a transmission unit that transmits uplink reference signals using a radio resource allocated from the base station in the period in which uplink reference signals are to be transmitted and stops transmitting uplink reference signals in period other than the period in which uplink reference signals are to be transmitted. According to this user equipment UE, a technique for enabling UL reference signals to be transmitted efficiently in a wireless communication system that includes the user equipment UE and the base station 10 is provided.

According to the embodiment, there is provided a transmission method executed by a user equipment in a wireless communication system that includes a base station and user equipments, the transmission method including: receiving allocations or radio resources to be used for transmitting uplink reference signals from the base station; measuring the reception quality of downlink signals transmitted from the base station; and starting transmitting uplink reference signals using a radio resource allocated from the base station when the measured reception quality satisfies a predetermined condition and stopping transmission of uplink reference signals when the measured reception quality does not satisfy the predetermined condition. According to this transmission method, a technique for enabling UL reference signals to be transmitted efficiently in a wireless communication system that includes the user equipment UE and the base station 10 is provided.

<Supplementary Explanation of Embodiment>

Notification of the information is not limited the aspect and the embodiment described in the present specification but may be performed by other methods. For example, notification of information may be performed via physical layer signaling (for example, DCI (Downlink Control Information) or UCI (Uplink Control Information)), upper-layer signaling (for example, RRC (Radio Resource Control) signaling, MAC (Medium Access Control) signaling, notification information (MIB (Master Information Block)), or SIB (System Information Block)), other signals, or by a combination thereof. Moreover, the RRC signaling may be referred to as a RRC message, and may be an RRC Connection Setup message, a RRC Connection Reconfiguration message, or the like, for example.

The respective aspects and embodiments described in the present embodiment may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), a system which uses other appropriate systems, and/or a next-generation system which is extended on the basis of these systems.

The orders in the processing procedures, the sequences, the flowcharts, and the like described in the respective aspects and embodiments described in the present specification may be switched unless contradiction occurs. For example, in the method described in the present specification, although various steps are illustrated in an exemplary order, the steps are not limited to the illustrated specific order.

A specific operation performed by the base station in the present specification may be performed by an upper node depending on a situation. In a network including one or a plurality of network nodes including a base station, it is obvious that various operations performed to communicate with terminals may also be performed by the base station and/or other network nodes (for example, MME or S-GW but not limited thereto) other than the base station. Although a case in which there is only one network node other than the base station has been illustrated in the above-described examples, a plurality of other network node combinations (for example, MME and S-GW) may be used.

The information, parameters, and the like described in the present specification may be expressed as absolute values, may be expressed as relative values from a predetermined value, and may be expressed as corresponding other information. For example, radio resources may be indicated by an index.

The base station 10 can accommodate one or a plurality of (for example, three) cells (also referred to as sectors). When the base station 10 accommodates a plurality of cells, the entire coverage area of the base station 10 can be subdivided into a plurality of smaller areas. The respective smaller areas can provide a communication service by a base station subsystem (for example, an indoor small base station RRH: Remote Radio Head). The term “cell” or “sector” indicates a portion or the entire portion of the coverage area of a base station and/or a base station subsystem that performs a communication service in this coverage. Furthermore, the terms “base station,” “eNB,” “cell,” and “sector” can be used interchangeably in the present specification. The base station may be referred to as terms such as a fixed station, a NodeB, an eNodeB (eNB), an access point, a femtocell, a small cell, and the like.

The user equipment UE may also be referred to by those skilled in the art as a subscriber station, a mobile station, a subscriber unit, a mobile unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terms.

The reference signal may be abbreviated as RS (Reference Signal) and may be referred to as a pilot signal or a pilot depending on the applied standards.

The expression “on the basis of” used in the present specification does not mean “on the basis of only” unless otherwise stated particularly. In other words, the expression “on the basis of” means both “on the basis of only” and “on the basis of at least”.

Any reference to elements which uses namings such as “first” and “second” used in the present specification does not generally limit the quantities or the order of these elements. These namings may be used in the present specification as a method convenient for distinguish two or more elements. Therefore, references to the first and second elements do not mean that only two elements can be employed therein or that the first element precedes the second element in any form.

To the extent that the expressions “including” and “comprising” and variants thereof are used either in the present specification or the claims, these expressions are intended to be inclusive in a manner similar to the expression “having”. Furthermore, the expression “or” used either in the present specification or the claims is not intended to mean “Exclusive-OR”.

In the entire present disclosure, when articles such as a, an, and the are added to an element in the translated English text, for example, such an element to which these articles are added may be provided plurally unless it is clear from the context that the element is provided singly.

The respective aspects and embodiments described in the present specification may be used solely, may be used in combination, and may be switched and used according to execution. Moreover, the notification (notification of “X,” for example) of predetermined information is not limited to being performed explicitly but may be performed implicitly (for example, without performing the notification of the predetermined information).

While the present invention has been described above in detail using the embodiment, it is obvious to those skilled in the art that the present invention is not limited only to the embodiment described in this specification. The present invention can also be embodied in other modified and altered forms without departing from the gist and scope of the present invention as defined in the appended claims. It is therefore to be understood that the disclosure of this specification is intended for the purpose of description and exemplification but is not intended to limit the scope of the invention.

Determination or judgment may be performed according to a value (0 or 1) represented by a bit, may be performed according to a boolean value (true or false), or may be performed according to comparison of numerical values (e.g., comparison with a predetermined value).

It should be noted that the terms described in the present specification and/or terms necessary for understanding the present specification may be replaced by terms that have the same or similar meaning. For example, a channel and/or a symbol may be a signal. Further, a signal may be a message.

An aspect/embodiment described in the present specification may be used independently, may be used in combination, or may be used by switching according to operations. Further, transmission of predetermined information (e.g., transmission of “it is X”) is not limited to explicitly-performed transmission. The transmission of predetermined information may be performed implicitly (e.g., explicit transmission of predetermined information is not performed).

As used herein, the term “determining” may encompasses a wide variety of actions. For example, “determining” may be regarded as calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining.

Input/output information, etc., may be stored in a specific place (e.g., memory) or may be stored in a management table. The input/output information, etc., may be overwritten, updated, or added. Output information, etc., may be deleted. Input information, etc., may be transmitted to another apparatus.

Information, a signal, etc., described in the present specification may be represented by using any one of the various different techniques. For example, data, an instruction, a command, information, a signal, a bit, a symbol, a chip or the like described throughout in the present specification may be represented by voltage, current, electromagnetic waves, magnetic fields or a magnetic particle, optical fields or a photon, or any combination thereof.

The present application is based on and claims priority to Japanese patent application No. 2016-166198 filed on Aug. 26, 2016, the entire contents of which are hereby incorporated by reference.

### EXPLANATIONS OF LETTERS OR NUMERALS

UE: User equipment
10: Base station
101: Signal transmission unit
102: Signal reception unit
103: Allocation unit
104: Measurement unit
201: Signal transmission unit
202: Signal reception unit
203: Reception unit
204: Measurement unit
1001: Processor
1002: Memory
1003: Storage
1004: Communication apparatus
1005: Input apparatus
1006: Output apparatus

1. A user equipment in a wireless communication system that includes a base station and the user equipment, the user equipment comprising:
a reception unit that receives allocations of radio resources to be used for transmitting uplink reference signals from the base station;
a measurement unit that measures reception quality of a downlink signal transmitted from the base station; and
a transmission unit that starts transmitting uplink reference signals using the radio resources allocated by the base station when the reception quality measured by the measurement unit satisfies a predetermined condition and stops transmission of uplink reference signals when the reception quality measured by the measurement unit does not satisfy the predetermined condition.

2. The user equipment according to claim 1, wherein
the radio resources allocated by the base station are allocated such that different radio resources are associated with corresponding ranges of the reception quality of downlink signals, and
the transmission unit selects a radio resource associated with the reception quality measured by the measurement unit and transmits uplink reference signals.

3. The user equipment according to claim 1,
wherein the transmission unit reports the reception quality measured by the measurement unit to the base station when starting transmission of uplink reference signals using the radio resources allocated from the base station.

4. A user equipment in a wireless communication system that includes a base station and the user equipment, the user equipment comprising:
a reception unit that receives allocations of radio resources to he used for transmitting uplink reference signals and a period in which uplink reference signals are to be transmitted; and
a transmission unit that transmits uplink reference signals using the radio resources allocated by the base station in, the period in which uplink reference signals are to be transmitted and stops transmitting uplink reference signals in a period other than the period in which uplink reference signals are to be transmitted.

5. A transmission method executed by a user equipment in a wireless communication system that includes a base station and the user equipment, the transmission method comprising:
receiving allocations of radio resources to be used for transmitting uplink reference signals from the base station;
measuring reception quality of downlink signals transmitted from the base station; and
starting transmitting uplink reference signals using the radio resources allocated by the base station when the measured reception quality satisfies a predetermined condition and stopping transmission of uplink reference signals when the measured reception quality does not satisfy the predetermined condition.

6. The user equipment according to claim 2,
wherein the transmission unit reports the reception quality measured by the measurement unit to the base station when starting transmission of uplink reference signals using the radio resources allocated from the base station.
